(19) United States
(12) Patent Application Publication
(10) Pub. No.: US 2005/0071239 A1
(43) Pub. Date: Mar. 31, 2005

(54) Consumer business search and commerce system

(76) Inventors: Peter James Tormey, Concord, CA (US); Richard Moerschell, Concord, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/661,045

(22) Filed: Sep. 12, 2003

(51) Int. Cl. G06F 17/60

(52) U.S. Cl. 705/26

(57) ABSTRACT

A system for gathering information which may further facilitate electronic commerce is disclosed. In one embodiment, the invention is a method including: receiving requests from one or more users for a specification of a product or service desired by the one or more users; determining vendors who potentially possess the good or service of interest to the one or more users; and outputting e-mails to said vendors requesting information about said good or service. The method may include searching a database having at least a relationship between key words searched by the one or more users and a set of vendors, searching the Internet using a commercially available search engine, or both. The method may further include the step of extracting emails from a set of results of said searching.

### BACKGROUND OF THE INVENTION

1. Field of the Invention

The present invention is directed to an information gathering system which has particular application as an electronic commerce system.

2. Description of the Related Art

Despite early hesitancy on the part of consumers, more and more goods and services are purchased over the Internet. In general, purchasing goods via the Internet is referred to as “E-commerce”. There are many mechanisms by which consumers can purchase goods and services using the Internet. Such mechanisms have evolved from simple storefront websites, to supermarket store sites, to more elaborate systems which aggregate results from many sites to bring consumers choices from several sites by searching the merchant sites and providing, on a web page, a listing of the search results. The mechanisms have evolved beyond simple retail purchase schemes to include auction systems, such as Ebay.com or alternative bid/purchase mechanisms such as Priceline.com.

The most basic means by which a consumer can purchase goods on the Internet is to simply go to a website providing the good or service, search the site, and purchase the desired item. Normally, however, the user needs to determine which of a number of sites will have the good or service the user wishes to purchase. The simplest means by which a user does this is illustrated in FIG. 1A. At step 10, the user will run a web-based search using a search engine, such as Google, or a web directory or portal, such as Yahoo. The user will input keywords that describe the good or service and will receive a number of results at step 20. Some sites, such as Google, include focused advertising based on the keywords with the search results. For example, if a user inputs a request for “blue jeans”, the user will receive hits of websites which provide, manufacture, or distribute clothing, as well as advertising for stores which the search engine has determined, based on the keyword input by the user, sell blue jeans or other types of clothing. Vendors pay a service fee to the search site to be included in the search results.

After receiving the results at step 20, the user still needs to visit the sites individually, at step 30, to retrieve information about the sites and make purchases. In this manner, the user can determine whether the site has the good or service of interest to the user.

Because the process illustrated in FIG. 1A is quite cumbersome and time-consuming, other mechanisms have evolved. Perhaps the most well-known of these is the shopping super site. These super sites provide a number of different types of goods and services (such as electronics, clothing, books, music, etc.) at one Web location, and provide an internal site search mechanism for the consumer to determine whether the site has the good or service the user is seeking. Purchasers are directed to purchase goods found at the site through a secure purchase system on the site.

Yet another evolution of E-commerce involves the commerce aggregation site. Examples of this type of site include Yahoo.com Shopping (shopping.yahoo.com) and My.Simon.com. The method used by a consumer to shop using an aggregator site is shown in FIG. 1B. These sites take keyword input from a user to search (as illustrated at step 40) a number of different E-commerce storefronts, including super sites such as Amazon.com, and Buy.com as well as smaller retailers, to retrieve products matching the user's keyword. Results of all hits on different sites are presented to the user in a sortable format, as illustrated at step 50. These results can be sorted by price, relevance, or other means, to allow the user to select, and/or to purchase, the good or service through the site, or directly from the site which results in the search. As shown at step 60, consumers have the option of using E-commerce funding mechanisms such as Yahoo Wallet or Microsoft's Passport to keep a record of the payment information preferred by the user on file, which may then be used to purchase goods and services from participating sites.

One problem with such aggregator sites is that they only search providers who have agreed to be included with the aggregator and who pay the aggregator a fee to be included in the aggregator's search. As a result, aggregator sites do not provide the breadth of information one would find as a result of searching an Internet-wide search engine, such as, for example, that used in the process described with respect to FIG. 1B. Another problem with the search super sites is that such sites may not provide a particular specific good or service that the user is attempting to find. Where the good is a very specific item or has particular characteristics, such as “red jeans”, the sites have a tendency to produce results for retailers selling all jeans or just trousers.

Hence, an E-commerce system which provides the user with the means to search for specific items and to receive results on a scale equaling that of results obtained through meta search engines, would be advantageous.

### SUMMARY OF THE INVENTION

The present invention, roughly described, pertains to a system for gathering information which may further facilitate electronic commerce.

In one embodiment, the invention is a method including: receiving requests from one or more users for a specification of a product or service desired by the one or more users; determining vendors who potentially possess the good or service of interest to the one or more users; and outputting e-mails to said vendors requesting information about said good or service. The method may include searching a database having at least a relationship between key words searched by the one or more users and a set of vendors, searching the Internet using a commercially available search engine, or both. The method may further include the step of extracting emails from a set of results of said searching.

In another embodiment, the invention is a method comprising the steps of: receiving requests from one or more users comprising a list of hits and a specification of a product or service desired by the user; outputting e-mails to vendors identified in the list as potentially possessing the good or service for sale to users; receiving e-mails from vendors interested in selling the good or service to the one or more users; and outputting vendor information.

In another embodiment, the invention is a method for conducting commerce on the Internet. In this embodiment, the invention may comprise the steps of: providing a customer agent including a keyword search field, a transaction type selector, and a descriptor file generator; and providing a control server including a receiver for customer agent query results based on input in the keyword search field, the input comprising a good or service, the query results contained in an e-mail including an encrypted descriptor file, the control server including an e-mail generator forwarding queries to merchants generated as a result of a keyword search.

In yet another aspect, the invention comprises a method for conducting business over the Internet. In this aspect, the method includes the steps of: generating a descriptor file in an independent data format, the file including a description of an item for which information is sought by a user; encrypting the descriptor file; forwarding the descriptor file with clear text description information to a plurality of vendors; receiving, from a subset of a plurality of vendors, information about the item; and outputting the information received to the user.

In another aspect, the invention is a system for conducting business over the Internet. The system includes at least one user agent including a search engine interface and a description file generator, coupled to the Internet. In addition, a control server is provided which is coupled to the Internet to receive descriptor files provided by the customer agent. The control server administers transmission of a descriptor file to merchants coupled to the Internet.

In yet another embodiment, the invention includes one or more processor readable storage devices having processor readable code embodied on said processor readable storage devices, said processor readable code for programming one or more processors to perform a method for conducting a transaction on the Internet. In this aspect, the invention includes the steps of: receiving input from a user regarding a product or service of interest to the user; interacting with a search engine to retrieve hits resulting from keyword input to said search engine; generating a descriptor file for the product or service; extracting e-mail addresses of site hits resulting from said search; and forwarding e-mails to said e-mail addresses including a request for additional information regarding the good or service of interest.

The present invention can be accomplished using hardware, software, or a combination of both hardware and software. The software used for the present invention is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers. These and other objects and advantages of the present invention will appear more clearly from the following description in which the preferred embodiment of the invention has been set forth in conjunction with the drawings.

### BRIEF DESCRIPTION OF THE DRAWINGS

The invention will be described with respect to the particular embodiments thereof. Other objects, features, and advantages of the invention will become apparent with reference to the specification and drawings in which:

FIG. 1A depicts a first prior art method for purchasing goods and services using the Internet.

FIG. 1B depicts a second prior art method for purchasing goods and services over the Internet.

FIG. 2A depicts a block level diagram of a first system according to the present invention.

FIG. 2B is a flow chart depicting one embodiment of the method of the present invention.

FIG. 2C is a flow chart depicting another embodiment of the method of the present invention.

FIG. 3 depicts a block level diagram of a second system according to the present invention.

FIG. 4 is a flow chart depicting another implementation of the method of the present invention.

FIG. 5 represents an exemplary screen layout for an application which is presented to a user in accordance with the present invention.

FIG. 6 is a second exemplary implementation of a screen layout used in an application in accordance with the present invention.

FIG. 7 is an exemplary screen layout showing a listing of results which are provided to the user in the system of the present invention.

FIG. 8 is a third exemplary screen layout utilized in the system of the present invention.

FIG. 9 is an exemplary screen showing a chart of purchased items in a screen layout in a system of the present invention.

FIG. 10 is a flow chart representing yet another embodiment of the method of the present invention.

FIG. 11 is a flow chart representing a further embodiment of the method of the present invention.

FIG. 12 is a flow chart representing a still further embodiment of the method of the present invention.

FIG. 13 is an exemplary screen layout representing how a user might select a search engine in accordance with the system of the present invention.

FIG. 14 is an exemplary screen layout representing how a user might select a local and target language, country, area code, and zip code for a search in accordance with the system of the present invention.

FIG. 15 is an exemplary screen layout representing how a user might choose the type of response the user wishes to receive from the system of the present invention.

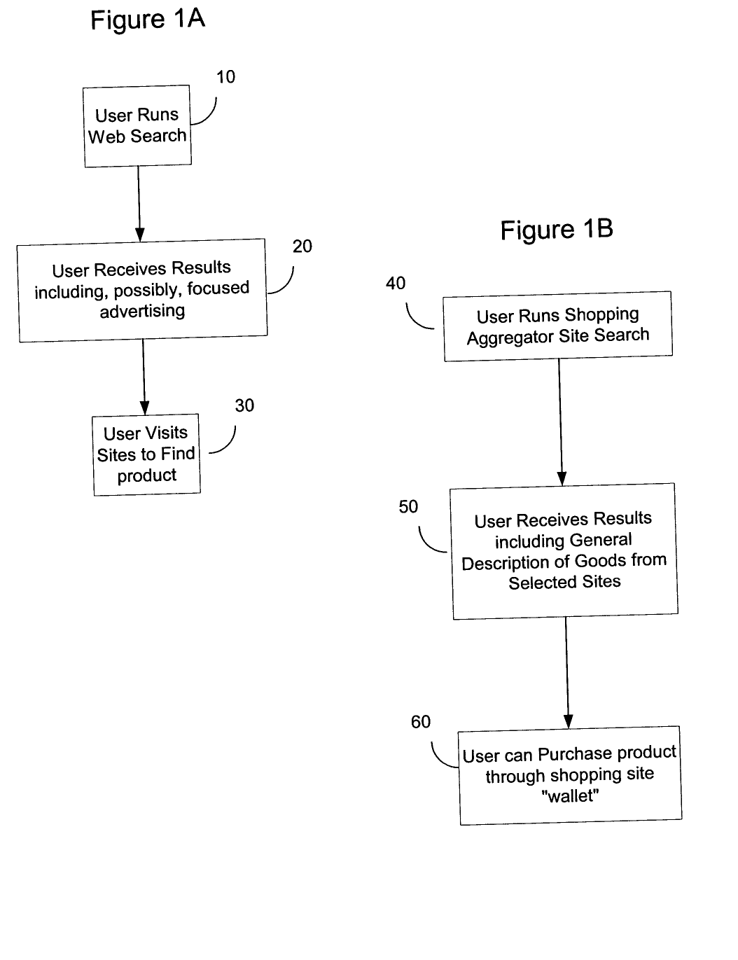

### DETAILED DESCRIPTION

The system of the present invention allows users to find goods and services on the Internet without needing to browse hundreds of websites. The system has particular advantages when purchasing hard-to-find products, and in aggregating various types of merchants. The system has additional applicability with respect to small businesses, who can subscribe to the system and receive e-mails from respective customers.

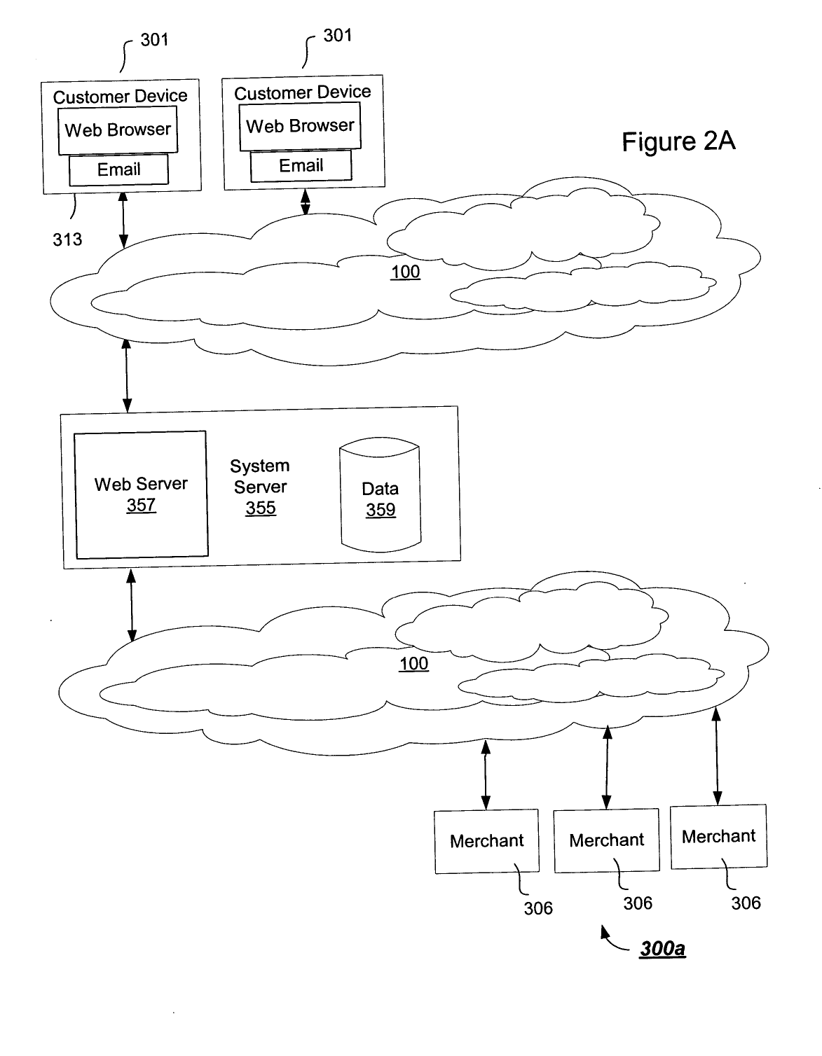

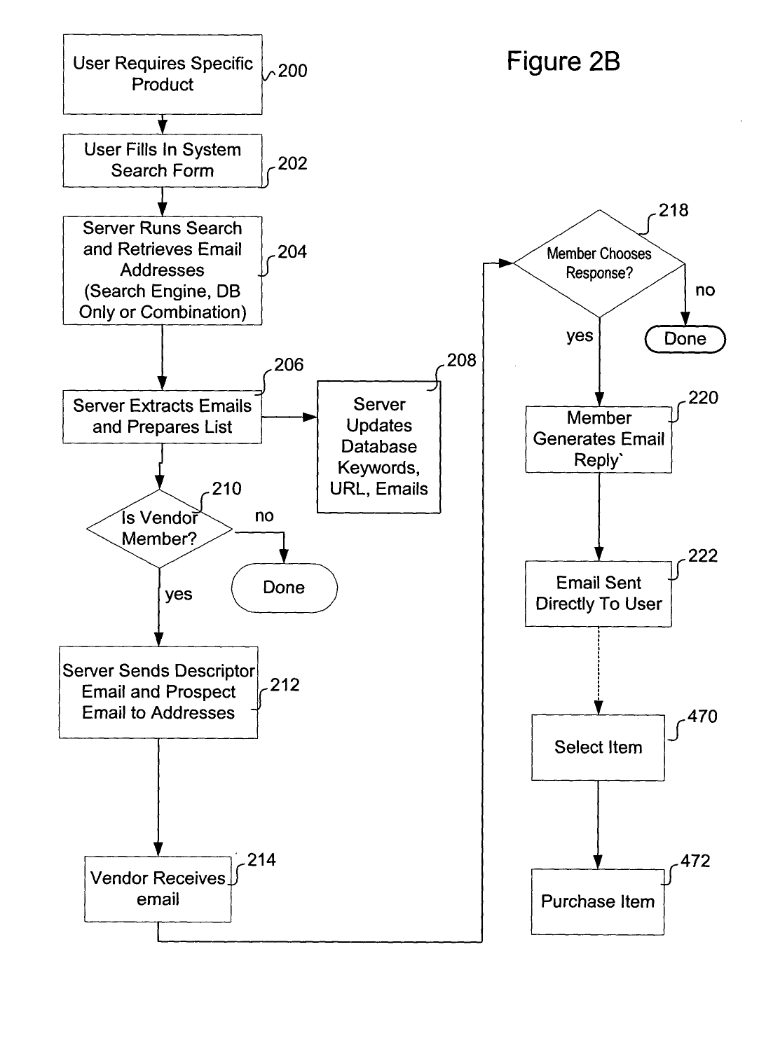

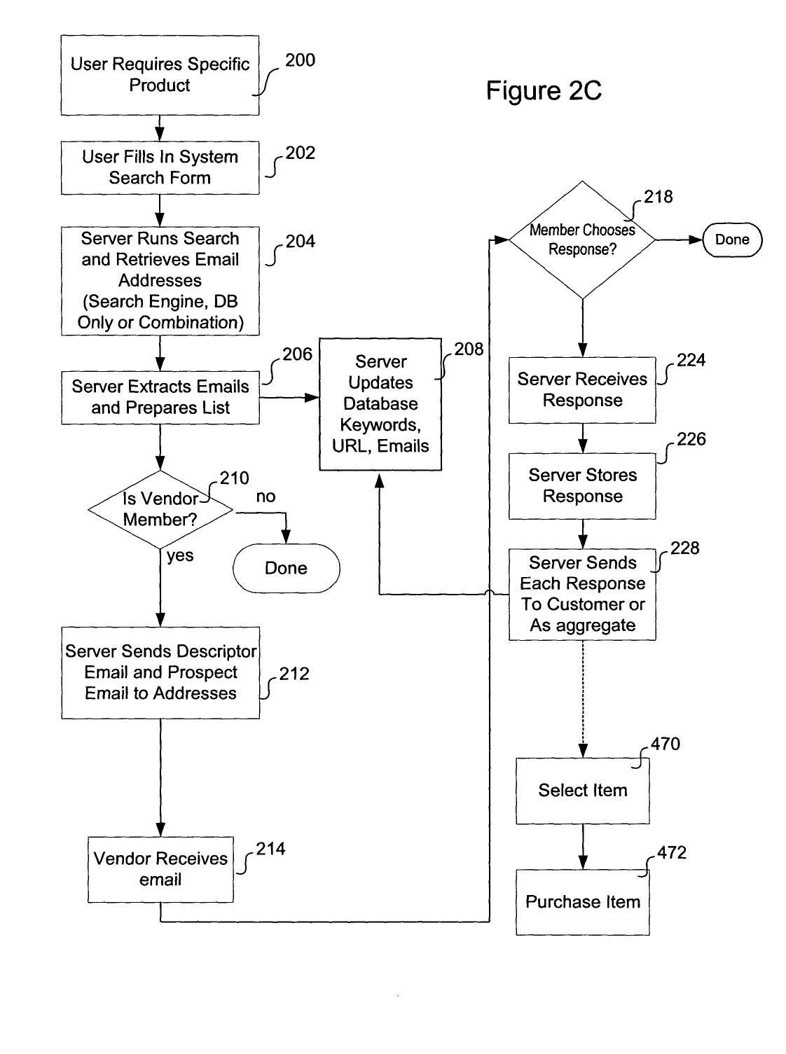

FIG. 2A shows a general block level diagram of a first system 300a according to the present invention. FIG. 2A shows a user device 301 with the ability to access a network, which may be a private network, or a combination of public and private networks such as Internet 100. It will be understood that any number of user devices 301 may be used by customers in accordance with the present invention. In FIG. 2A, devices 301 is are labeled a “customer device” for the sake of ease in understanding the invention. Also shown are a plurality of “merchant” devices 306 having the ability to access a network. In addition, a system server 355 used for providing information to the customer and merchant devices is shown. As will become clear, there is no necessary distinction between the hardware used to provide a customer device, merchant device or server 355 within the context of the invention. In addition, as described below, because users who are normally customers can also choose to sell items via system 300a (and merchants can purchase articles via the system), customers can be merchants and vice versa.

A hardware architecture for the machines, server or other devices such as devices 301, 306, 355 and like devices shown in other embodiments discussed herein, which may used to implement the present invention should be well understood to one of average skill in the art. Suitable hardware includes one or more processors, a memory, a mass storage device, a portable storage device, one or more network interfaces and I/O devices, in communication with each other. The choice of processor is not critical as long as a suitable processor with sufficient speed is chosen. The memory can be any conventional computer memory. The mass storage device can include a hard drive, CD-ROM or any other mass storage device. The portable storage can include a floppy disk drive or other portable storage device. If the computer is acting as a router, it includes two or more network interfaces. In other embodiments, the computer may include only one network interface. The network interface can include a network card for connecting to an Ethernet or other type of LAN. In addition, one or more of the network interfaces can include or be connected to a firewall. I/O devices can include one or more of the following: keyboard, mouse, monitor, display, printer, etc. Software used to perform the methods of the present invention are likely to be stored in mass storage (or any form of non-volatile memory), a portable storage media (e.g. floppy disk or tape) and/or, at some point, in memory. The above described hardware architecture is just one suitable example depicted in a generalized and simplified form. The present invention could include dedicated hardware, a dedicated router with software to implement the invention or other software and/or hardware architectures that are suitable.

System server 355 may include Web server software 357 and a database 359, the functions of which are described below. The Web server software may be any of a number of commercially or freely available web servers. Likewise the database may be implemented using any number of commercially or freely available databases, or may be implemented with a custom database. Both the customer device 301 and merchant devices may further include email software and/or web browsing software. The system is operable over intranets or the Internet using standard Web browsers, such as Microsoft Internet Explorer (MSIE), Netscape Navigator, or the like, on standard customer computing processing devices, including WebTV™, RIM, Blackberry, or any other Internet appliance, such as Internet capable personal communication service (PCS) devices. The system may be implemented in software and hardware, and may be proprietary or open source. The system is also extensible, and thus may employ other or future communication or presentation standards, as desired or as they become available.

FIG. 2B illustrates a first method of the present invention using the system implementation shown in FIG. 2A. At step 200, a user will have a need or desire to obtain a specific product. Accordingly, the user has some information about the product that the user desires to find. At step 202, the user will fill in a system search form. In this embodiment, the form may be provided by the system server 355 via any number for suitable formats (HTML, JSP, ASP, etc.) interpreted by a web browser on the customer device. In step 202, the user may provide a description of the product sought in one or more fields on the form. For example, a user may seek a digital camera having a certain megapixel capacity, storage, optical zoom and/or brand.

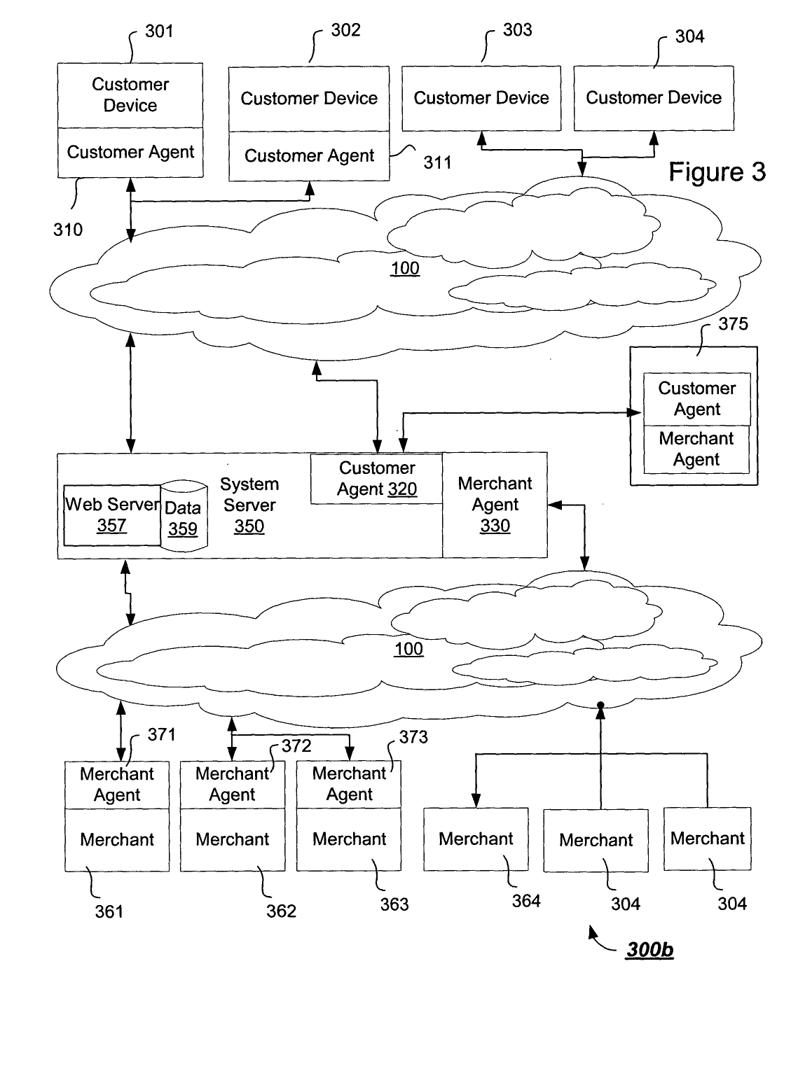

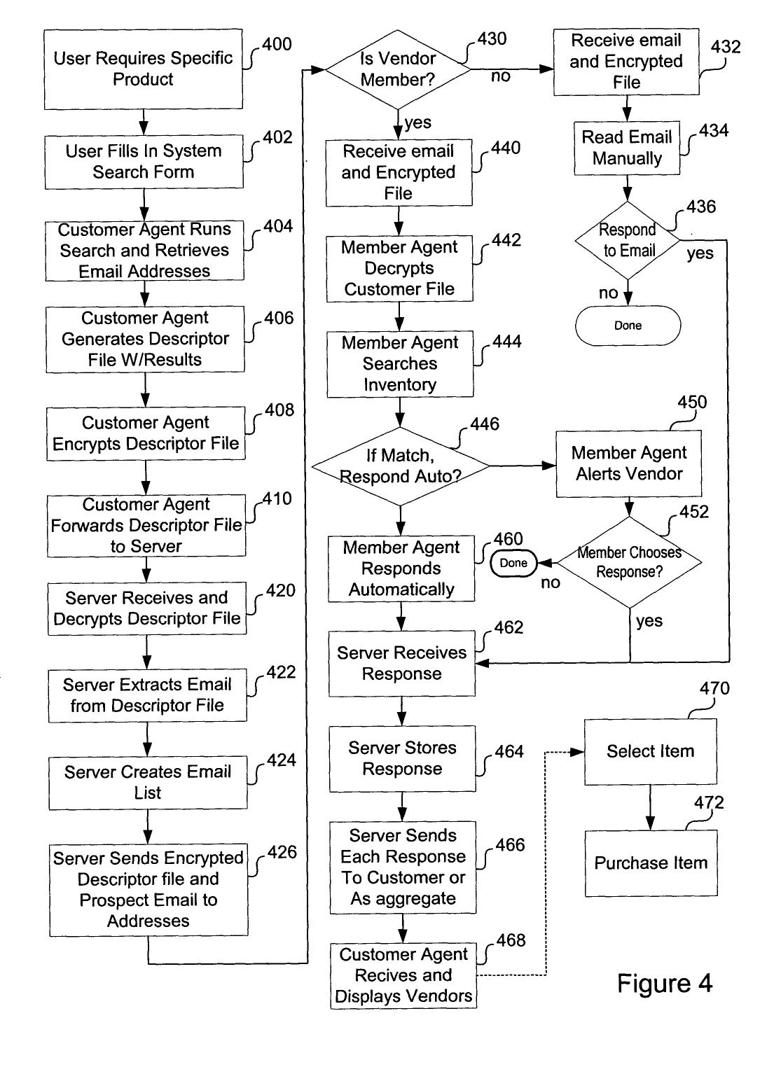

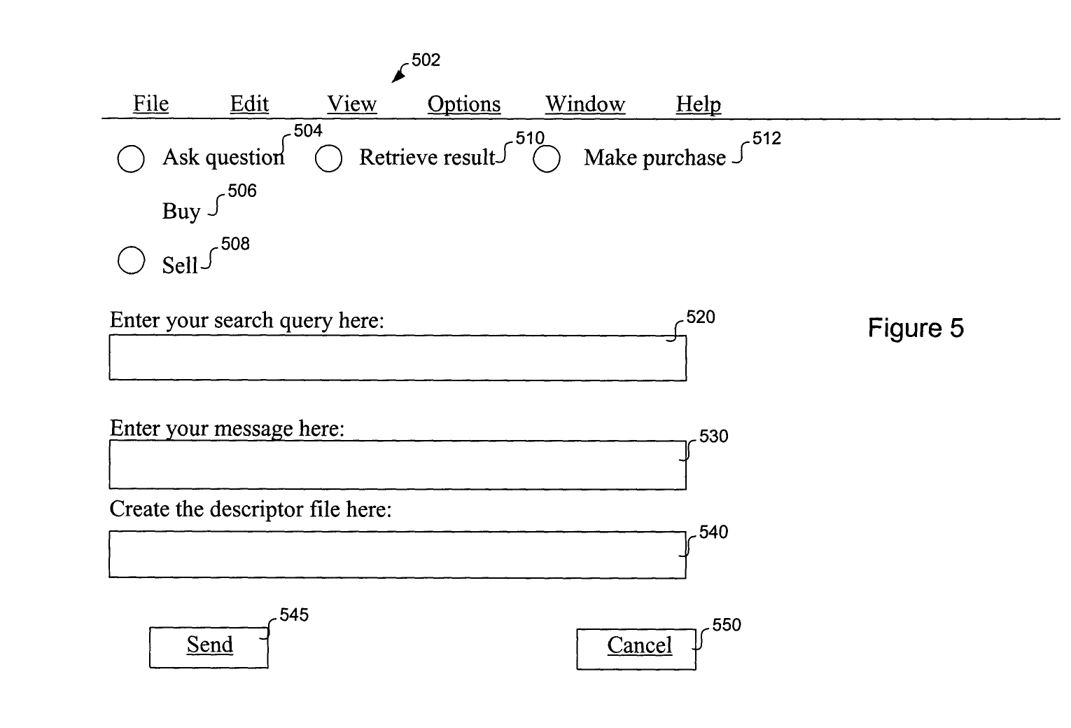

The search form screen may take the format shown in FIG. 5. FIG. 5 shows an exemplary program screen which may be provided by the web server and interpreted by the browser on a customer device. Alternatively, the screen may be provided by an agent on the user device as discussed in the embodiment of FIGS. 3-4. In the present embodiment, the screen of FIG. 5 need not have field 540, as a “descriptor file” is not being used. After the user fills in the system search form at step 202, the server 355 runs a search at step 204 and retrieves a listing of websites which potentially meet sever keyword criteria specified in the search query field of the form. At step 404, the server 355 performs the search using an internet search engine, the information in the database 359 or both. The database, in this embodiment, includes data relating key words commonly searched by users to website and email information. Such websites will be sites that indicate they are potential vendors of the product sought in step 200. The search may be performed using any of a number of standard search sites, such as Yahoo, Google, or the like. For example, the data store may associate the key word “camera” with one or more websites known to provide information about, or sell, cameras, and one or more email addresses associated with the website domain. This can increase the responsiveness of the system. The database may additionally store weighting information based on the number of times the domain responds to customer requests, as described below. It should be noted that the server 355 may maintain a filter list of e-mail addresses or domains which have opted out of receiving e-mails from users of the system. An exemplary data record might include a set of relations between tables such as: a keyword index table; a domain table; a responsiveness factor table; a table reflecting whether a domain has sold products; a user rating table; and other factors.

After retrieving new results from the search, at step 404, the server at step 406 will parse the results of the search and determine e-mail addresses for all websites retrieved as a result of the search. Email addresses may be retrieved using standard search parsing. For example, many sites use standard e-mail addresses such as postmaster@abcdef.com, webmaster@abcdef.com, information@abcdef.com, sales@abcdef.com, or the like. As described below, if the site subscribes to a service provided by an administrator of the system of the present invention, the site may provide meta field tags to indicate to the customer agent a particular address for use by the system of the present invention.

In an optional step, the system may check, at step 210, whether domains belonging to potential vendors are part of a subscription service provided by an administrator of the present invention. In such embodiment, the membership will determine whether the vendor will receive information regarding the customer query, or an alternative contact indicating that the vendor could receive additional information soliciting the vendor's involvement in the service.

At step 212, the server 355 sends a description email containing information about the product sought by the user to emails in the address list regrieved at step 206. The descriptor email is an explanatory e-mail listing the reason for the e-mail, which in a “buy” transaction will be to determine whether the e-mail recipient has the good or service of interest and is willing to sell it, and information on the good or service sought. The email may contain further information on making the merchant's domain more accessible by the system 300a. In one example, the e-mail forwarded by the server to the addresses generated by the search may include a link or reply e-mail address to allow merchants receiving e-mail inquiries from the system to opt out of receiving additional e-mails.

The vendors will receive the email at step 214 and will determine whether the vendor wishes to respond at step 218. If the vendor wishes to respond, then in this embodiment, the vendor will generate an email reply to the user at step 220 and send the reply directly to the user at step 222. In this embodiment, where communication takes place between the vendor and the user directly, the email may be copied to an address received by server 355 which allows updating of the database on the server with information about the responsiveness of the vendor and the domain, as described above. The dashed line in this embodiment indicates that this updating is optional.

Finally, as indicated at steps 470, the user may select the item and purchase the item at step 472. In one embodiment, this transaction takes place between the user and the vendor directly.

In this system, opportunities for revenue generation by the system administrator include charging for access to the service by the user and the merchant, as well as charging for preferential access to customers by vendors.

FIG. 2C shows an alternative embodiment of the method of the present invention. All steps up to step 218 are the same as those set forth in FIG. 2B. When a member chooses to respond to the query at step 218, instead of the user directly receiving the email as in the embodiment of FIG. 2B, the response address provided to the vendor is an address which is provided to the server 355. In this case, the server receives the response at step 224 and may store the response at step 226. Storage of the response is not required, but allows for the system to use the information in the email to update the database and, at step 228, to send the information to the user as an individual email or an aggregate of a number of emails. In one embodiment, the server will simply forward the email on to the user without updating the database. In a further embodiment, the information in the mail, or the simple fact that a user from the domain responded to a user query, can be used to update information about the user in the database.

Next, the user may wish to purchase the device at steps 470 and 472. In this embodiment, the purchase transaction may be facilitated by the system administrator. For example the email from the server supplied at step 228 may include a link to an online transaction center where the user can provide an order for the item to the vendor. Vendors may link to the same transaction center and the sale may be facilitated by the administrator. The administrator may charge a flat fee for each transaction or a percentage of the transaction fee for use of the service.

FIG. 3B shows a general block level diagram of a second system 300b of the present invention. FIG. 3B shoes a plurality of user devices 301, 302, 303, or 304, each with the ability to access a network, which may be a private network, or a combination of public and private networks such as Internet 100. Again, devices 301, 302, 303, or 304, are labeled “customer devices” for the sake of ease in understanding the invention; there is no necessary distinction between the hardware used to provide a customer device, merchant device or server 350 within the context of the invention. In addition, as described below, because users who are normally customers can also choose to sell items via system 300 (and merchants can purchase articles via the system), customers can be merchants and vice versa.

Customer agent software 310, 311 may be installed on customer devices, such as customer devices 301 or 302, or the customer device may access the system using a customer agent 320 which is integrated with the system server 350. The customer agent 320 may be in the form of a website or web browser providing the services of the customer agent as described herein. Likewise, a plurality of merchants interact with system server 350 using processing devices 361 through 366 which connect to a network, such as Internet 100. Merchants may be users having Internet storefronts or users who do not have storefronts but wish to provide services and products to customers using customer devices 301 to 304. To access the system of the present invention, some merchants, such as merchants 361 through 363, will have a merchant agent installed on a merchant device. Merchant agents 371 through 373 are installed on merchant agent devices 361-363, respectively. Merchant devices 364 through 366 interact with the merchant agent 330 integrated with the system server 350. This means that the merchants 364 need not install any separate software on their machines to participate in accordance with the system of the present invention. In addition, devices 301-304 and 361-366 may have e-mail access through a dedicated client on the device, or may access any of a number of Internet Portal based web-e-mail services to use the system of the present invention.

In one implementation, both the merchant agent and the client agent may be provided on the same device or integrated as a single piece of software providing both customer and merchant functions.

In one aspect of this embodiment of the present invention operates using standard Web browsers on the customer devices. In this instance a Customer Agent or Merchant Agent may comprise: A browser plug-in, TCP/IP socket applications running on the customer, JAVA applets or ActiveX objects, and any other systems that enhance the customer functionality beyond existing HTML functionality. While the content is described as textual, the presented content may include audio, video, multimedia, or other information.

Generally, the customer agent 310, 311, 320 takes input from the customer in a manner similar to the form used in step 202, but provides additional functionality and security. Such input includes: a transaction type, such as a buy, a sell, or an information request; a transaction category, indicating a good or service; a description of the good desired; and solicited data, which may include the availability, price, specifications (size, color, volume, or other more specific information) which is identified in the descriptor file as field information to be used in the reply to the server. The customer agent uses this input to create a descriptor file which concisely defines the customer's request. This file can be automatically translated to and from English or any other language. In one embodiment, the system allows customers to also manually edit the descriptor file. The customer also uses this information to perform a web search with standard search engines, using the customer's query. The search agent captures all e-mail addresses resulting from the hit list, which may include meta tag addresses found on sites which are compliant with the system of the present invention. The customer agent then sends a request to the server which contains the customer query, the encrypted descriptor file, and, optionally, a system site header, allowing the vendor to know where to go to register to participate in the system of the present invention. The customer also receives replies from the server, displays the transaction type, category, description and data in the reply, and provides order as specified by the customer to the replies.

The system server 350 receives requests from various customers and merchants, and ensures that the customer is properly registered in the system of the present invention. In some embodiments, it e-mails request from other customers to the addresses on the list. In other embodiments, it merely provides permission to the customer to enable the customer to send the e-mail directly to the customer. The server also receives responses from the query e-mails, processes the responses by stripping out any banner, pop-up windows, or other advertising, culls the responses to make an optional aggregate reply, and formats the data in responses to create the reply to the customer agent. The system then provides the reply to the customer, either individually or as an aggregate reply. The system server may include a purchasing element which allows customers to order their products from the business through the server, and a marketing database capturing and associating market data for each customer in each type of search. In a further embodiment, the system server may include a search database which stores a list of websites, e-mail addresses, and specific keywords. The database can be used to search for e-mail addresses and merchants who have decided not to participate in the program and not receive additional e-mails from users using the system. The server can generate aggregate replies from the database which contain responses from businesses to a specific request. The server also maintains an organized list of meta tags allowing any business to access and utilize these meta tags on their site for free (in one implementation), whether or not the business is a subscriber to the system of the present invention. These meta tags can be employed to identify which words on a website represent which words in an e-mail address that the system of the present invention should use to communicate with products that are for sale, and other features. Businesses participating in the system of the present invention receive responses from the server, a merchant agent which can decode descriptor files, and automatically generate and respond to server-provided requests.

FIG. 4 shows an embodiment of a method in accordance with the system of FIG. 3 the present invention. At step 400, a user will have a need or desire to obtain a specific product. Accordingly, the user has some information about the product that the user desires to find. At step 402, the user will fill in a customer agent search form. The customer agent search form may take the format shown in FIG. 5. FIG. 5 shows an exemplary program screen being provided by the customer agent installed on the device, as described above with respect to FIG. 3B, or through a web browser coupled to a system server 350 or a separate web server (not shown) in accordance with the system. The customer agent query screen has a menu bar 502 with several standard menu items, such as FILE, VIEW, EDIT, WINDOW and HELP, and also an OPTIONS menu, as will be described below. The screen has several “radio button” selection interfaces, including an asked question button 504, a buy button 506, a sell button 508, a retrieve result button 510, and a make purchase button 512. The interface also includes query fields 520, 530, 540, which will change, depending on the particular function which the application is providing.

In FIG. 5, button 506 is selected, indicating the user wishes to buy a product. In this particular instance, the text fields will provide an “enter your search query here” field 520, an “enter your message here” text field, and a “create descriptor file here” 540. The search query field 520 may include keywords or indicators of the particular product or service which the user is attempting to find. The message text field 530 may include a particular message which the user wishes to impart to the prospective vendor. Examples of this message include “Do you have a 3 megapixel camera with 3× optical zoom, 32 MB memory and a smart card feature”. Also shown is a “create descriptor file” field 540, which provides the user with a means for saving the descriptor file to a physical location on the user's hard drive or network drive. The interface also includes a send button 545, and a cancel button 550, which transmit the information provided in the fields of FIG. 5 or cancel transmission as the case may be.

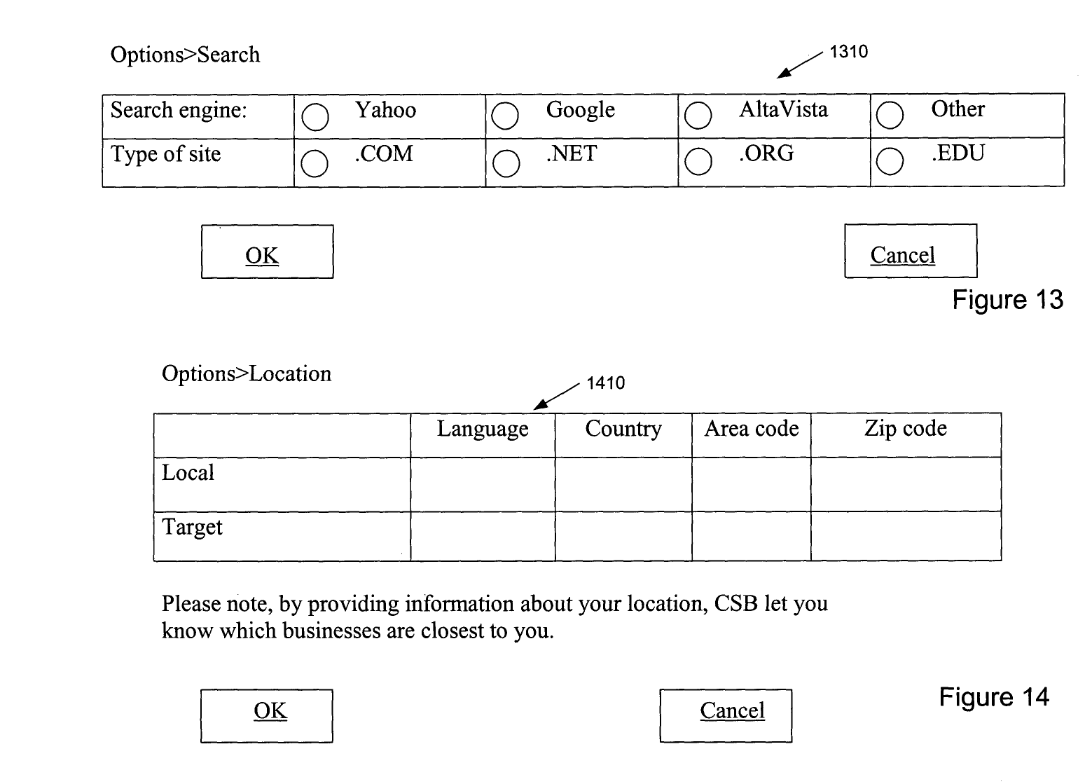

Returning to FIG. 4, after the user fills in the system search form at 402, the customer agent runs a search at step 404 and retrieves a listing of websites which meet the criteria specified in the search query field 520. The search may be performed using any of a number of standard search sites, such as Yahoo, Google, or the like. As with the embodiment of FIGS. 2b and 2c, this search may be performed on a database which includes information associating keywords with information on vendors who participate in the system. As shown in FIG. 13, the user may be provided with an option to select which search agents the user wants to use for the search. After retrieving new results from the search, at step 404, the agent will parse the results of the search and determine e-mail addresses for all websites retrieved as a result of the search. Email addresses may be retrieved using standard search parsing. For example, many sites use standard e-mail addresses such as postmaster@abcdef.com, webmaster@abcdef.com, information@abcdef.com, sales@abcdef.com, or the like. As described below, if the site subscribes to a service provided by an administrator of the system of the present invention, the site may provide meta field tags to indicate to the customer agent a particular address for use by the system of the present invention.

Upon retrieving the e-mail addresses, at step 406, the customer agent will generate a descriptor file with the results of the e-mail addresses included therewith. The descriptor file will include query information and product information from both fields 520 and 530, which will be used by other elements of the system of the present invention to search for goods and services. The descriptor file will be in an extensible mark-up language (XML) format. It should be recognized that other formats, such as XML schema, HTML, SGML, or the like, may be utilized. XML provides a particular advantage in that it transverses multiple data formats and languages. However, the descriptor file may also be provided in any of a number of other formats, including a text file.

After generating the descriptor file, at step 406, the customer agent encrypts a descriptor file at step 408. Using encryption prevents the descriptor file from being intercepted by individuals not part of the system of the present invention, and protects the customer's privacy in the search query. Any of a number of encryption techniques may be used including public or private key encryption, cryptographic hash algorithms, and/or cryptographic signing. Once encrypted, at step 410, the customer agent forwards the descriptor file, along with the e-mail addresses encoded therein, to the system server. At step 420, the system server receives the descriptor file and decrypts the information therein. In one embodiment, the e-mails were extracted at step 404. In this embodiment, the server, at step 422, extracts the e-mail lists from the hit list provided in the descriptor file. Alternatively, the server may be provided with the list of URLs from the search in the descriptor file, and the server may process the list to determine associated e-mails. At step 424, the server creates an e-mail list of addresses from the descriptor file and at step 426, the server sends the encrypted descriptor file to e-mail addresses on the list. The descriptor file is sent along with an explanatory e-mail listing the reason for the e-mail, which in a “buy” transaction will be to determine whether the e-mail recipient has the good or service of interest and is willing to sell it; the descriptor file; and information on making the merchant's device more accessible by the system 300.

It should be noted that the server 350 may maintain a filter list of e-mail addresses or domains which have opted out of receiving e-mails from users of the system. In one example, the e-mail forwarded by the server to the addresses generated by the search may include a link or reply e-mail address to allow merchants receiving e-mail inquiries from the system to opt out of receiving additional e-mails.

Next, the steps which occur in the method will depend on whether or not the vendor who receives the e-mail is a member of the system of the present invention. In accordance with the system, it is contemplated that a system administrator will maintain and support the system 300, including server 350, and the customer and merchant software agents. The administrator can set the system to retrieve revenue in various forms. If the merchant desires to be a member of the system, the merchant can subscribe to the system, allowing the merchant to be authenticated when information is sent to the merchant, and install the merchant agent on their Internet-accessible device. In another embodiment, the administrator may make meta-tag information available to merchants to enable the merchants to identify particular aspects of the merchants' business to users of the customer agent. This may include the general inquiry e-mail address, type of goods, sale terms, and other information, such as the fact that the merchant is a “preferred system merchant”. This allows the customer agent to more easily retrieve information for that merchant.

At step 430, the method branches in accordance with whether or not the vendor is a member of the system. If the vendor is not a member, then the vendor, at step 432, will receive an e-mail and an encrypted descriptor file. The vendor will not be able to decrypt the encrypted file, however, the query information provided to the vendor will be in clear text form. At step 434, should the vendor wish to participate in the system 300, the vendor will be required to read each e-mail which he receives as a result of this system manually, and at step 436, the vendor may choose or not choose to respond to the e-mail. If the vendor responds to the e-mail, this e-mail will be sent to a server which receives the response at step 462.

Returning to step 430, if the vendor is a member of the system of the present invention, the vendor will receive the e-mail and the encrypted file at step 440. The member agent, on behalf of the vendor, will automatically decrypt the customer's descriptor file at step 442. Optionally, the member agent may search the inventory at step 444 to determine whether the vendor has a possible match to the query. The results of the search may be shown to the merchant, or may be directed to an automated response routine. In this manner, the merchant need not respond manually if the merchant so desires; this allows complete automation of the query process.

At step 446, the vendor may choose to have the merchant agent automatically respond to the search request. If the vendor chooses not to have the agent respond automatically, the agent may be set to alert the vendor at step 450 and allow the member, at step 452, to choose the type of response the vendor wishes to make. If, at step 446, the vendor chooses to allow the member agent to respond automatically, then, at step 460, the member agent will send an e-mail to the server, which the server will receive at step 462. Responses of all three branches of the variations described herein are received by the server at step 462.

At step 464, the server stores the responses received from the interested vendors. The server 350 can store the responses for a predetermined period of time or simply pass on e-mails as received, at step 466, depending on the selection of the customer. Alternatively, the server can provide an aggregated response, described below. At step 468, the customer agent will receive the responses from interested vendors and display this information to the user in a manner specified by the user. This receipt step 468 may be automatic, or may be prompted by the user.

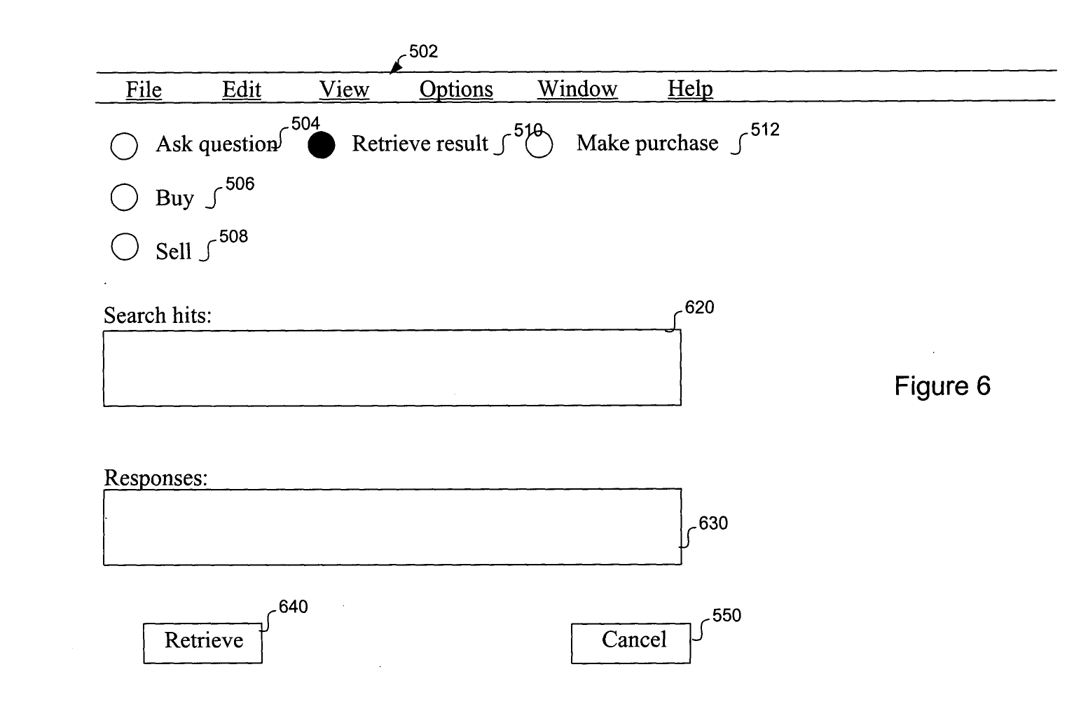

FIG. 6 shows an exemplary screen which is displayed to a user when the user clicks the retrieved result button 510 to retrieve results as described with respect to step 466. This retrieved result button brings up new text fields 620 and 630. The search hit field 620 allows the user to view the hits which the query entered in field 520 has retrieved. Responses field 630 allows the user to view responses from the vendors for any responses to the server.

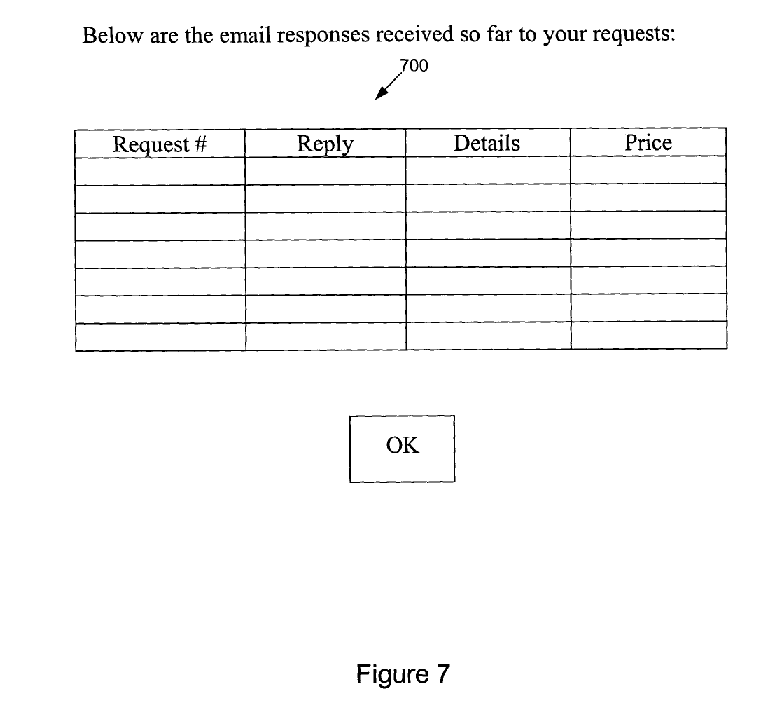

The format of the vendor responses may be such as that shown in FIG. 7. In FIG. 7, a table 700 lists a request number, a reply, details of the reply, and the price of each item in the particular results list. The request number may indicate the number of a multiple of requests the user has provided. The reply may include specific information about the vendor and the product. Details may include color, fabric indicated, or other specific information about the product which may not have been specified in the search query field 520.

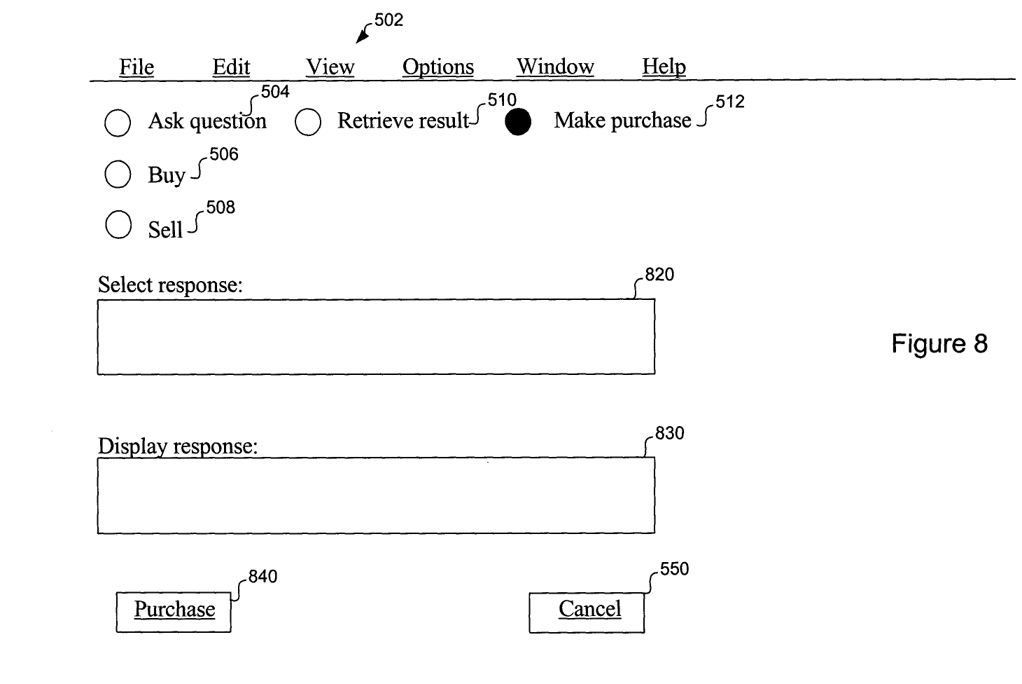

FIG. 8 shows an exemplary display screen which may be used when the user selects one of the items provided in the list of FIG. 7. By clicking on the make purchase button, the user is provided with two additional fields—a select response field 820 and a display response field 830. The user can then indicate his desire to purchase the product selected in FIG. 7 by clicking the purchase button 840.

Returning to FIG. 4, a dashed line between steps 468 and 470 indicates that steps 472 and 470 are optional. Using information provided by various vendors, at step 470, the user may select the item he is interested in purchasing, and purchase the item at step 472, using the system server. The system server may act as a commerce intermediary between the vendor and the customer. In alternative embodiments, discussed below, the user may purchase the information directly from the vendor.

At this point, the purchase may send credit card information directly to the vendor, or to the system server which may act as an intermediary between the customer and the vendor.

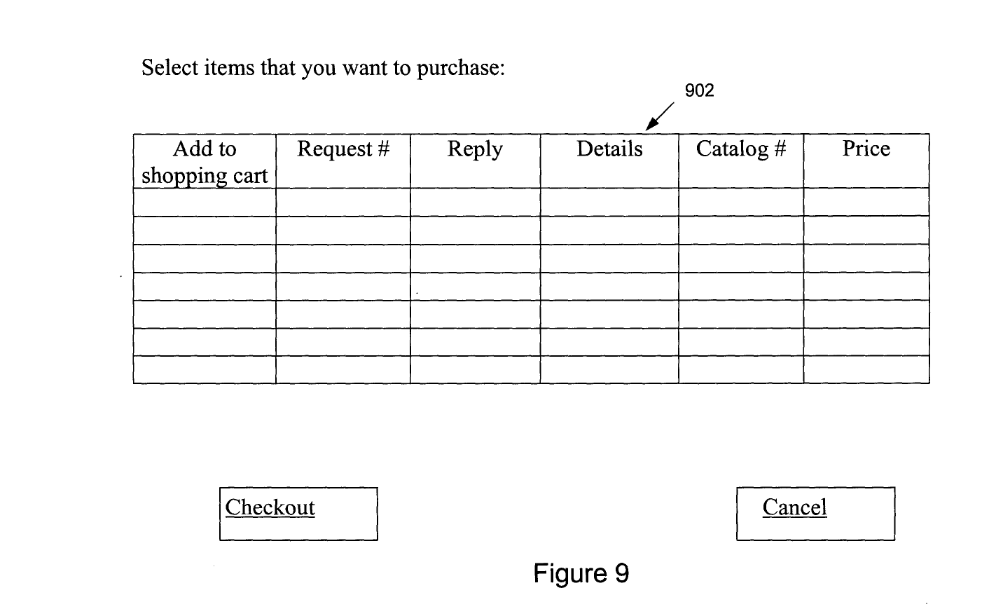

FIG. 9 is a screen which may result when the user clicks the purchase button from FIG. 8. The table 902 in FIG. 9 displays items which are added to the shopping cart, the request number, the reply from the vendor, any details shown in FIG. 7, a catalog number, if provided by the vendor, and a price. Clicking the checkout button 904 takes the user to specific information which the user needs to provide in order to check out. This may be a user name and password to access stored credit card or other information, or may be a secure field for providing credit card information to the vendor.

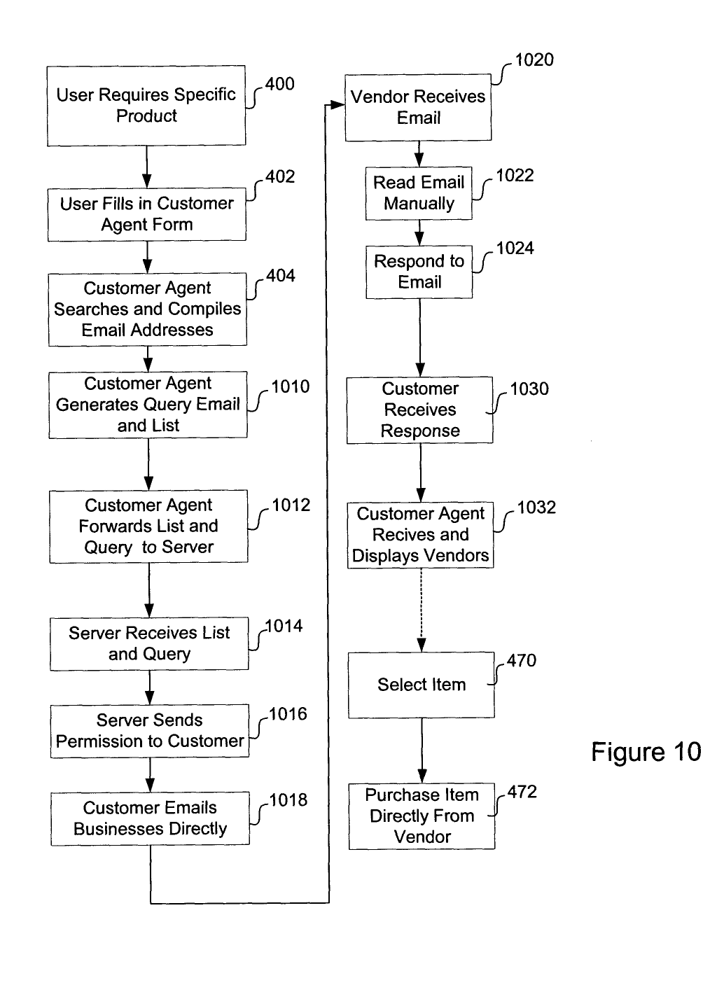

FIG. 10 displays an alternative embodiment of the present invention. In this embodiment, like numerals indicate steps which are similar to this at FIG. 4. In this embodiment, the customer agent takes on more responsibility and the system server merely provides permissive instructions to the customer agent. Steps 400, 402, and 404 operate as described above with respect to FIG. 4. Following step 404, in which the customer agent has searched and compiled e-mail addresses, at step 1010, the customer agent generates a query e-mail and a list of the hits which it has received, and, at step 1012, forwards the list in the query to the system server. At step 1014, the server receives the list inquiry and parses the list for e-mails (either retrieving an e-mail list created by the client or parsing the hit list for e-mail entries, as described above). Again, the server may check the list against a list of certain vendors which have requested not to receive additional e-mails from the system of the present invention.

Once the server has determined that the user is not on a “do not mail” list, the server sends permission to the customer agent at step 1016, indicating that the customer may forward the e-mail directly to vendors which it has received as a result of its search. At step 1018, the customer agent generates the query e-mail and sends it to each of the businesses directly.

At step 1020, the merchant receives the e-mail which, in this case, will not include a descriptor file, but will include a description of the product or service which the vendor desires to purchase. At step 1022, because there is no descriptor file, each vendor will need to read each e-mail manually and respond to each e-mail at step 1024. In this embodiment, the customers receive e-mails directly at step 1030 and the customer agent may sort and display aspects of the e-mail at step 1032. Again, the user can choose to select the item at step 470 and purchase the item directly from the vendor at step 472. It should be noted that the customer agent may parse information from the e-mail and display it in the table of formats or may simply display the e-mail response from the vendor as it is received. This reduces load on the server, but increases load on the customer agent.

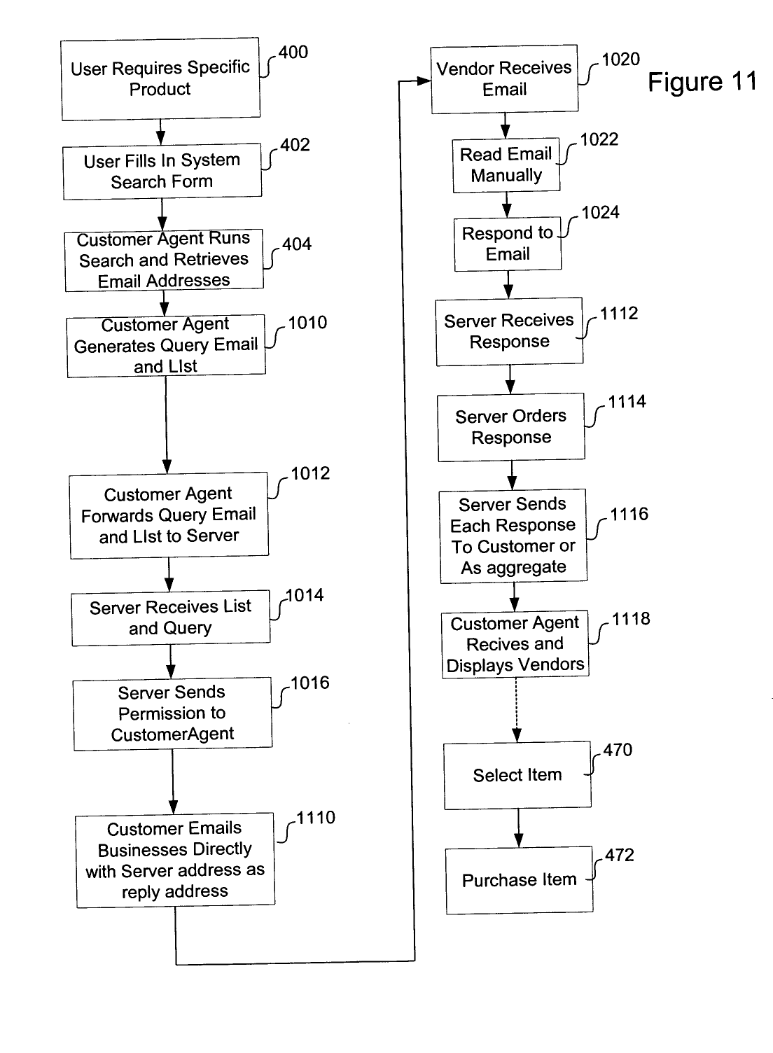

FIG. 11 shows another alternative embodiment of the present invention wherein the server provides slightly more processing effort than that disclosed with respect to FIG. 10. In the embodiment of FIG. 11, steps 400 through 404 are once again performed in the manner as described above with respect to FIG. 4. Steps 1010, 1012, 1014, and 1016 are performed in a manner as described above with respect to FIG. 10. Following the server sending permission to the customer to e-mail vendors directly in step 1016, the customer e-mails businesses at step 1110 directly, but provides an e-mail address for server 350 as the reply address in the e-mail. When the vendor receives the e-mail at step 1020, reviews the e-mail at step 1022, and responds to the e-mail at step 1024, the response will be sent directly to the server. At step 1112, the server will receive the response, and, at step 1114, store the response in a manner similar to that described above with respect to FIG. 4 at step 464. The server may send each response to the customer individually, or as an aggregate response at step 1116. The customer agent will receive the individual or aggregate response at step 1118, and display it to the user as described above.

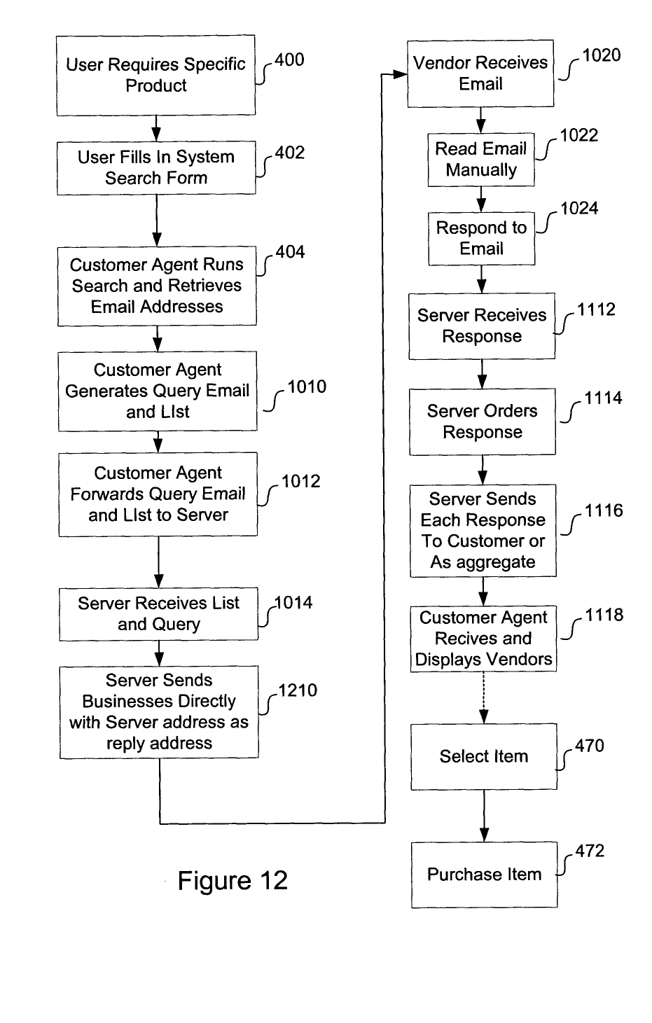

FIG. 12 shows a fourth embodiment of the system of the present invention. In the embodiment in FIG. 12, again the server performs a bit more processing than that described above with respect to FIG. 10. Steps 400, 402, 404, 1010, 1012, and 1014 are performed as described above with respect to FIGS. 4 and 10 respectively. Once the server has received the hit (or e-mail) list and query instructions at step 1014, in accordance with the embodiment of FIG. 12, the server sends businesses e-mails directly at step 1012. Again, the server address is provided as the reply address. This means that the customer agent does not need to provide the e-mails to the vendors itself. At step 1020, the vendor receives the e-mail, reviews the e-mail at step 1024, and responds to the e-mail at step 1026. As in FIG. 11, the server will receive the response at step 1112, order the response and provide the information to the customer agent at step 1116.

FIG. 13 shows a selection menu to allow the user to select any of a number of meta search engines utilized by the customer agent. Shown therein is a menu 1310 with radio buttons to allow the users to select “Yahoo,” “Google,” “Altavista,” or an “other” search engine.

In addition, the user can restrict the search to a particular type of domain suffix, such as a .com, .net, org, or .edu.

FIG. 14 shows how the user may select different languages, countries, area codes, and zip codes to indicate to the system where the user is from, the “local” settings, and where the user desires to search the “target settings.” Once the user selects the local and target locations, the system of the present invention can sort through physical information about the target vendor and provide the user with information as to which vendors are physically closest to the customer. Because the information in the descriptor file is, in one embodiment, XML format, the file and its contents can be easily translated to other languages, allowing the query to be directed internationally.

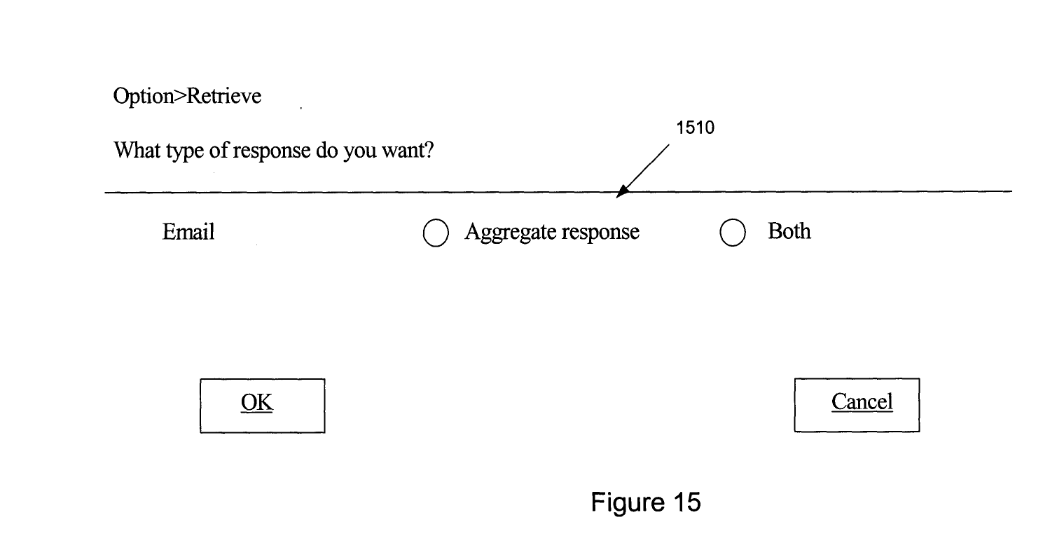

FIG. 15 shows an option screen allowing the user to select the type of responses that the user will receive from the system of the present invention in response to a query. As shown therein, radio buttons allow the user to select an individualized e-mail response, an aggregate response, or both. Selecting the “OK” button will indicate to the system that the user has made a selection and desires to implement that selection.

The system provides a number of unique advantages. Customers are allowed to get what they want, even when what they want is very specific and only provided by specialized vendors. The system allows for translation of the information provided in the descriptor file to various different languages. Vendors who participate in the system of the present invention are provided with advantages, and the vendors who do not participate are provided with advantages by receiving requests from users normally visiting only large scale aggregation web-sites.

In a still further aspect of the invention, returning to FIG. 5, a “Sell” button allows merchants or customers to place particular items up for sale. This may be implemented by providing the “sale” item information such as catalogs to a database on the server which is searched when relevant queries arrive, enabling the customer agent as a merchant for the time period when items are to be sold, or simply operating the system in reverse, with the “sell” button operating a search for merchants who might be interested in purchasing goods or services sold in the descriptor field provided by the seller.

In yet another embodiment, the customer agent and the merchant agent may comprise a single agent performing both functions, or may be separate pieces of software. In the latter embodiment, both agents may be provided on the same physical processing device.

It should be understood that the invention may be implemented entirely in hardware, entirely in software, or in a combination of both. In one embodiment, the customer agent, member agent and server are provided on one or more processor readable storage devices.

In a further aspect of the system, the invention includes generating revenue from the operation of the system 300 or portions thereof. Methods of generating revenue in accordance with the invention include: charging a fee from the customer for client software; charging a fee from the merchant for business software; charging a fee from the customer for the number of e-mail requests sent; charging a fee from the merchant for the number of replies passed to customers; charging a fee from the merchant for access to marketing database; charging a fee from the merchant for context sensitive ads (such as banner ads) sent to client software; charging a fee from the merchant for decryption key to decrypt the descriptor file; charging a fee from the merchant for programming service to automatically couple the descriptor file with the business's catalog; charging a fee from the customer for the number of replies received from the businesses; charging a fee for handling the purchase transaction when customer buys a product; and charging a fee from the merchant for giving their site priority when a particular set of search terms are employed.

The foregoing detailed description of the invention has been presented for purposes of illustration and description. It is not intended to be exhaustive or to limit the invention to the precise form disclosed. Many modifications and variations are possible in light of the above teaching. For example, many of the tasks described as being provided on a server or client may be moved to other machines, and server tasks may be moved to the client and client tasks to the server. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method for gathering information on the Internet, comprising:
receiving an electronic request from one or more users for a specification of a product or service desired by the one or more users via an input form provided by a server;
determining vendors who potentially possess the good or service of interest to the one or more users; and
outputting e-mails to said vendors requesting information about said good or service.

2. The method of claim 1 wherein the step of determining comprises:
searching a database having at least a relationship between key words searched by the one or more users and a set of vendors.

3. The method of claim 1 wherein the step of determining comprises searching the Internet using a commercially available search engine.

4. The method of claim 3 further including the step of extracting emails from a set of results of said searching.

5. The method of claim 1 wherein the step of determining comprises searching a database having at least a relationship between key words searched by the one or more users and a set of vendors and searching the Internet using a commercially available search engine.

6. The method of claim 1 further including the step of receiving e-mails from vendors interested in selling the good or service to the one or more users.

7. The method of claim 6 further including the step of outputting vendor information to the one or more users.

8. The method of claim 6 further including the step of updating a datastore with weighting information on vendors.

9. The method of claim 1 wherein the method is performed on a server coupled to the Internet.

10. A method for conducting commerce, comprising:
receiving requests from one or more users comprising a list of hits and a specification of a product or service desired by the one or more users;
outputting e-mails to vendors identified in the list as potentially possessing the good or service for sale to the one or more users;
receiving e-mails from vendors interested in selling the good or service to the one or more users; and
outputting vendor information to the one or more users.

11. The method of claim 10 wherein the step of receiving includes receiving a descriptor file containing the product specification.

12. The method of claim 11 wherein the descriptor file is formatted in XML.

13. The method of claim 11 wherein the descriptor file is encrypted.

14. The method of claim 10 wherein said steps are performed on a server coupled to the Internet.

15. The method of claim 14 wherein the step of receiving comprises receiving an e-mail including an encrypted descriptor file from a customer agent on a user device.

16. The method of claim 15 wherein the descriptor file includes e-mail addresses extracted from the list of hits.

17. The method of claim 10 wherein the step of outputting e-mails is performed by a user device.

18. The method of claim 10 wherein the step of outputting e-mails includes providing an intermediary e-mail address not associated with said one or more users.

19. The method of claim 10 wherein said step of receiving e-mails from vendors is performed by the server.

20. The method of claim 10 wherein said step of receiving e-mails from vendors is performed by a user device.

21. The method of claim 10 wherein the step of outputting vendor information includes outputting each e-mail received from vendors.

22. The method of claim 10 wherein the step of outputting vendor information includes outputting a summary of the e-mail received from vendors.

23. The method of claim 10 further including the step of receiving a request from a user to purchase a product or service and performing a monetary exchange between the user and the vendor.

24. A method for conducting commerce on the Internet, comprising:
providing a customer agent including a keyword search field, a transaction type selector, and a descriptor file generator; and
providing a control server including a receiver for customer agent query results based on input in the keyword search field, the input comprising a good or service, the query results contained in an e-mail including an encrypted descriptor file, the control server including an e-mail generator forwarding queries to merchants generated as a result of a keyword search.

25. The method of claim 24 wherein the step of providing includes providing a software agent operable on a processing device.

26. The method of claim 24 wherein the step of providing includes providing a World Wide Web based server and programming code operable in a Web browser.

27. The method of claim 24 further including the step of providing a merchant agent.

28. The method of claim 24 wherein the merchant agent is integrated with the customer agent.

29. The method of claim 24 wherein the step of providing a customer agent includes providing an encryption routine for the descriptor file, and the step of providing a control server includes providing a decryption routine for the descriptor file.

30. A method for conducting business over the Internet, comprising:
generating a descriptor file in an independent data format, the file including a description of an item for which information is sought by a user;
encrypting the descriptor file;
forwarding the descriptor file with clear text description information to a plurality of vendors;
receiving, from a subset of a plurality of vendors, information about the item; and
outputting the information about the item received to the user.

31. The method of claim 30 wherein the independent data format is XML.

32. The method of claim 30 wherein the step of encrypting is performed on a user device.

33. The method of claim 30 wherein the step of forwarding is performed by an intermediate server.

34. The method of claim 33 wherein the step of forwarding comprises forwarding the descriptor file by e-mail.

35. The method of claim 34 wherein the step of forwarding further includes the step of not forwarding information to vendors indicating they do not wish to receive such information.

36. The method of claim 30 wherein the step of forwarding is performed by a user device and the method includes a step of granting permission to a user device to selectively perform said step of forwarding.

37. The method of claim 30 wherein the step of generating includes running a World Wide Web search using a search engine and recording results of the search.

38. The method of claim 37 wherein the step of generating includes extracting e-mail addresses from the results.

39. The method of claim 30 wherein the step of receiving includes receiving information by e-mail.

40. The method of claim 30 wherein said step of outputting comprises outputting e-mails received from said vendors.

41. The method of claim 30 wherein said step of outputting comprises outputting an aggregate of e-mails containing said information about the item.

42. A system for conducting business over the Internet, comprising:
at least one user agent including a search engine interface and a description file generator, coupled to a network; and
a control server coupled to the network to receive descriptor files provided by the customer agent, the control server administering transmission of a descriptor file to merchants coupled to the network.

43. The system of claim 42 wherein the at least one user agent includes at least a customer agent and a merchant agent.

44. The system of claim 42 wherein the at least one user customer agent includes an agent operable in a Web browser application.

45. The system of claim 42 wherein the at least one agent includes code operable on a processing device.

46. The system of claim 42 wherein the at least one user agent and the server include a description file encryptor and decryptor.

47. The system of claim 42 wherein the description file generator outputs a description file in Extensible Markup Language.

48. The system of claim 42 wherein the at least one user agent includes an e-mail address extractor.

49. The system of claim 42 wherein the control server includes a blocked merchant database.

50. The system of claim 42 wherein the user agent transmits the descriptor file to merchants and the control server includes a user agent controller controlling transmission of the descriptor file.

51. The system of claim 42 wherein the control server transmits the descriptor file to merchants and the control server includes an e-mail server controlling transmission of the descriptor file.

52. One or more processor readable storage devices having processor readable code embodied on said processor readable storage devices, said processor readable code for programming one or more processors to perform a method for conducting a transaction on the Internet, comprising:
receiving input from a user regarding a product or service of interest to the user;
interacting with a search engine to retrieve hits resulting from keyword input to said search engine;
generating a descriptor file for the product or service;
extracting e-mail addresses of site hits resulting from said search; and
forwarding e-mails to said e-mail addresses including a request for additional information regarding the good or service of interest.

53. One or more processor readable storage devices in accordance with claim 52 wherein the step of generating the descriptor file includes formatting the file in XML.

54. One or more processor readable storage devices in accordance with claim 52 wherein the step of generating the descriptor file includes encrypting the file.

55. One or more processor readable storage devices in accordance with claim 52 wherein the step of forwarding comprises forwarding an encrypted descriptor file from a customer agent on a user device.

56. One or more processor readable storage devices in accordance with claim 52 wherein the descriptor file includes e-mail addresses extracted from the hits.

57. One or more processor readable storage devices in accordance with claim 52 wherein the method further includes the step of receiving e-mails from vendors responsive to the request.

58. One or more processor readable storage devices in accordance with claim 57 wherein the method further includes outputting each e-mail received from vendors to the user.

59. One or more processor readable storage devices in accordance with claim 52 wherein the method includes a summary of the e-mails received from vendors to the user.
